(19) United States
(12) Patent Application Publication
(10) Pub. No.: US 2019/0172085 A1
(43) Pub. Date: Jun. 6, 2019

(54) AWARDED CONTENT EXCHANGER MANAGEMENT SYSTEM

(71) Applicant: Paulo Roberto Jannotti Newlands, Rio de Janeiro (BR)

(72) Inventor: Paulo Roberto Jannotti Newlands, Rio de Janeiro (BR)

(21) Appl. No.: 15/831,881

(22) Filed: Dec. 5, 2017

(51) Int. Cl. G06Q 30/02; H04W 4/00; H04L 29/08; H04N 21/23

(52) U.S. Cl. CPC G06Q 30/0217; H04N 21/23; H04L 67/10; H04W 4/008

(57) ABSTRACT

The Awarded Content Exchanger Management System, from now on referred to just as Ace System, is provided for collective and simultaneous digital streaming of sound and video packages as from a pivot to groups of individuals forming a crowd gathered in the same venue, at the same moment and for the same common objective, being said streaming captured by smartphones equipped with an equivalent, responsive and dedicated APP fitted with the means for rewarding the End users of those smartphones.

### FIELD OF THE INVENTION

The present invention relates generally to the field of computing network systems and, in particular, to systems and methods for managing and sending a huge amount of messages containing sound and video packages also comprising a proportional amount of prizes to a large amount of End Users of smartphones equipped with an equivalent and responsive APP.

### BACKGROUND OF THE INVENTION

Each day more, the wireless digital communication is playing from one side an increasingly important role in human activities, both by the common people and companies.

And from the other side, it is being each day more common the concentration of amounts of people inside open or closed venues ranging from small groups up to the large crowds, to perform collective activities either for leisure as in the case of events in sportive stadium, for religion in the case of periodical cults in churches, for labor in the case of meetings for training or negotiations in offices, for artistic shows in the case of presentation of bands for mass attendants, among a countless possible examples where digital packages loaded with visual and sound contents are spread out over the whole venue in order to be received by everyone therein gathered.

It happens, however that sometimes the amount of people and the size of the venue, or even the noise produced not only by the local attendants of the programs, but also from outsider noise sources might badly interfere in the good quality of said content, spoiling therefore the final results expected for those programs.

In addition, the desired level of interaction between the attendants and the content being exhibited will not eventually reach the ideal quality and depth due to the fact that said proposed sound and visual communication is spread out as a whole over the entire audience, without any individualization by each attendant.

As such, viewing the messages and hearing the sounds jointly with the general public present would not assist the individual user in understanding customized messages in the proper desired context causing therefore the interaction between public and program to be incomplete.

It would be therefore highly desirable to have a system and method capable of organizing and displaying a plurality of messages containing sound and video packages sent to the public in an individualized manner even when they are gathered in the same venue and for the same purpose, provided that they could have available smartphones loaded with the proper and equivalent APP, in such a way that the same packages of sound and video will could be received by all of them in real time, at the same time and for the same purpose through an individualized system of data transmission.

It would be also highly desirable that all messages containing sound and video packages sent to the public be related to a same topic of common interest allowing them to use the individualized transmission to have them deeply immersed in the content of the programs increasing therefore the individual participation in each program.

### Description of the Related Art

Among a large assortment of digital APPs currently offered to the users of mobile devices, the present patent is mainly concentrated in the streaming of video and sound packages that might have an interesting connection with the activities users are performing in a given moment and place, and more especially when they are gathered around a specific reason which is common to everyone who is present there. Streaming of video and sound packages is already known in the digital state of the art and the services and results they instantly deliver are becoming each day more identified with human's life and habits.

### SUMMARY OF THE INVENTION

In one embodiment, the Ace System comprises a dedicated APP aimed to be loaded to the user's smartphone who are registered in the system and who wants to access it when participating in a given program of general interest.

In another embodiment, the Ace System comprises that the dedicated APP be under the administration and control of a Package Provider unit through which all requested packages, loaded with audio and video contents passes, are selected and then forwarded directly to the End Users of the system.

In another embodiment, the Ace System comprises the utilization of wired or wireless streaming technology such as BLUETOOTH, WIFI as well as any other technological mean that might be available at the selected venues, to stream audio and videos packages, transfer data and broadcast contents, programs or information between devices.

Still in another embodiment, the Ace System comprises a Package Provider unit, or server, which might digitally receive and transmit packages loaded with audio and video contents, streamed from a variety of Content Sources.

Still in another embodiment, the Ace System of the present invention comprises the emissions of packages for streaming audio and video contents from Content Sources to a plurality of users of smartphones equipped with an equivalent responsive APP and capable therefore to receive said emitted packages.

Still in another embodiment, the Ace System comprises a plurality of users of smartphones fitted with an equivalent responsive APP capable to search and receive digital packages loaded with audio and video contents, those users gathering in a common venue for attending to a program of common interest.

Still in another embodiment, the Ace System comprises the ability of concurrently and in real time streams through the user's smartphone devices the same audio and videos programs that in a given moment are being reproduced locally through the common audio and video means locally existing.

Still in another embodiment, the Ace System comprises a variety of Content Sources of video and audio packages previously logged in the Package Provider unit and activated through password codes.

Still in another embodiment, the Ace System includes the ability of keeping the streaming of the video and audio packages towards the smartphones sets fully synchronized to the same timing pace of the video and audio programs being streamed by the audio and video means available locally at the same moment.

Still in another embodiment, the Ace System includes the ability to outfit the smartphones with an electronic or mechanic device that gives the user the alternative possibility of using individual speakers such as the earphones or headphones for example, either jointly or not with regular speakers of the smartphones.

Still in another embodiment, the Ace System includes the deployment of a permanent or provisional hardware structure for the streaming of audio and video packages at the selected venue in order to support the high volume of accesses from End Users.

Still in another embodiment, the Ace System includes the ability of the Package Provider unit for simultaneously receiving and processing firstly a plurality of logins aimed to open up the Package Provider's data base for searching of audio and video digital packages from a plurality of user, and secondly the ability of streaming out the selected audio and video digital packages by that plurality of logged in users.

Still in another embodiment, the Ace System includes the creation of a dedicated social network among the users of a specific program in which they will be entitled to evaluate, for instance, the strong and weak points observed in the content presented by that program.

Still in another embodiment, the Ace System includes the ability of associating, gathering and processing all End User's doubts, queries and evaluations about the content of the program's exhibited themes such as an anthem, a program, a class at the school or at office, a music show, a sports session or any other event selected by those users in the available database at the Packages Provider Unit or at the Content Sources, or even at the Internet, according to a menu displayed at the smartphone's screen which can also be accessible by other means such as a voice searcher or any other compatible mean.

Still in another embodiment, the Ace System includes rewarding the users with prizes, pursuant to theirs participation in the system's programs.

### BRIEF DESCRIPTION OF THE DRAWINGS

The aforementioned features and advantages of the invention as well as additional features and advantages thereof will be more clearly understood hereinafter as a result of a detailed description of preferred embodiments of the invention when taken in conjunction with the drawings.

FIG. 1 schematically illustrates one embodiment of the users-server based network system according to the present invention;

FIG. 2 is a schematic view of the primary and secondary networking circles encompassed by the system;

FIG. 3A is a flowchart illustrating the first stage for the creation of an operational network encompassing the End Users, the Package Provider and the Content Sources.

FIG. 3B is a flowchart illustrating the second stage for the creation of an operational network encompassing the End Users, the Package Provider and the Content Sources.

FIG. 3C is a flowchart illustrating the third stage for the creation of an operational network encompassing the End Users, the Package Provider and the Content Sources.

FIG. 4 gives a top view of a plurality of Ace System users attending a game in a stadium;

FIG. 5 is a flowchart illustrating the routine for the creation of a quiz chart to be answered by End Users aiming to be eligible to win prizes;

FIG. 5A is a screenshot of an End User's smartphone comprising a code automatically generate by the Package Provider's server with which he will have the chance to win some of the prizes available;

FIG. 5B is a screenshot of an End User's smartphone comprising an example of quiz to be answered by him in order to be eligible to win prizes;

FIG. 5C is a screenshot of an End User's smartphone comprising link to access the quiz results;

FIG. 5D is a screenshot of an End User's smartphone comprising the summary of the final results of the End Users' grades.

FIG. 5E is a screenshot of an End User's smartphone informing that he has been awarded, showing as well an instruction link for receiving the prize.

FIG. 6 schematically illustrates the embodiment of a system for selling awarded tickets. For a fuller understanding of the nature of the present invention, reference should be had to the following detailed description taken in connection with the accompanying drawings in which:

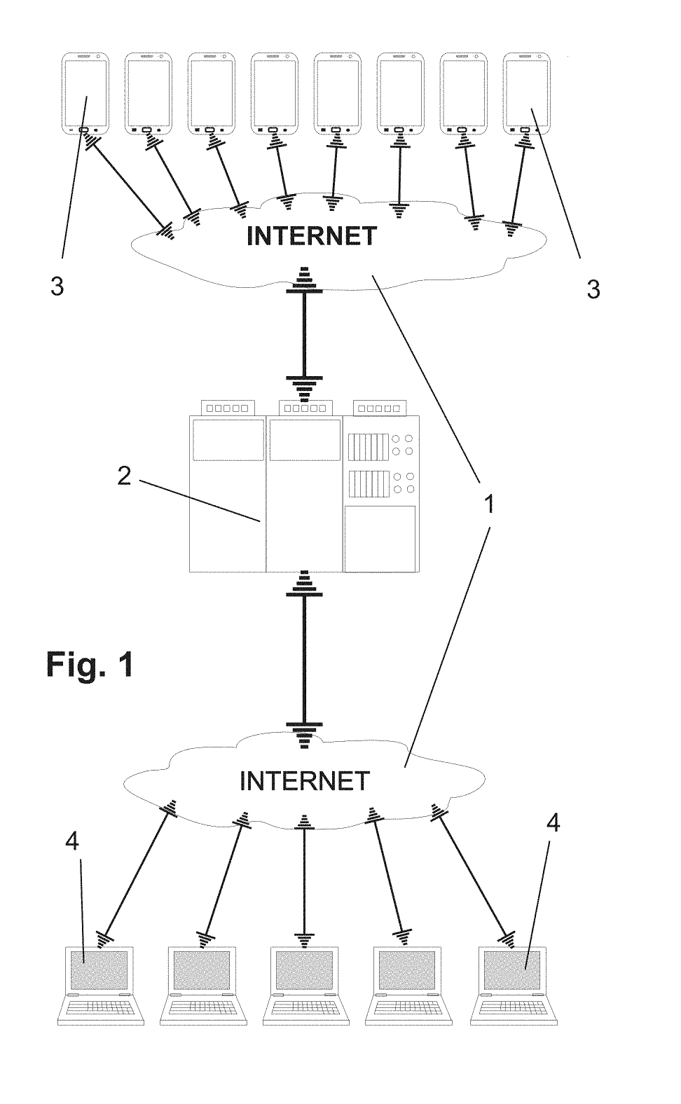

FIG. 1 schematically illustrates one embodiment of the Packages Provider-End Users-Content Sources which all together comprise an information circle aimed to exchange high volume of data through Internet Environment (1).

The Packages Provider (2) embeds all necessary means to accomplish its functions as the central axis of the Ace System.

Outfitted with the required hardware and software devices including strong servers attended by multiple internet connections, the Packages Provider (2) is in charge of the administration of the whole Ace System and therefore capable of processing simultaneously a huge amount of data coming in and going out from its related partners namely the End Users (3) and the Content Sources (4).

The digital relationship network so created leads the Packages Provider (2) to be able to get in close contact with the others members of that digital circle as the head member of the group, being the one which holds the administration power to start, manage and finish all the programs created within the system's environment which greatly benefits the speediness of the program's operations apart of enhancing its maximum security and conformity.

The End Users (3), who are actually the main reason not only for the existence of the Ace System but also for all events for massive public, must be considered as the orientation driver for the show business to elect which are the preferences and tendencies that should be observed by the entrepreneurs of this economic segment when defining their activities and projects.

As such it is essential not only to know, understand and analyze theirs behaving before, during and after those spectacles but mainly give them a strong, averaged and reliable group voice to ascertain with a minimum of certainty their evaluation level about the programs presented, preferably through a rewarding quiz system that might assure a genuine participation of them all.

And finally closing the primary digital networking circle, the so called Content Sources (4) are formed by entities or even regular people that can supply the system with the necessary content to allow the formulation of the questions that are to be submitted to the End Users (3) so they can, based upon of theirs answers, be entitled to receive the prizes determined by the system.

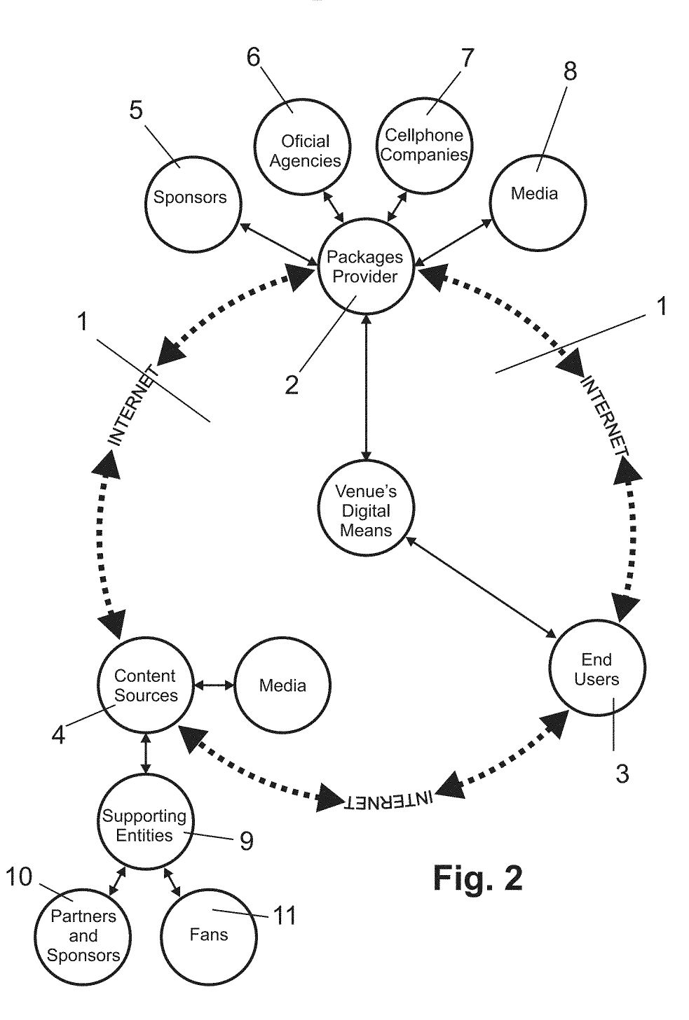

FIG. 2 schematically illustrates another embodiment of the Packages Provider-End Users-Content Sources circle around an Internet Environment (1), now including additional layers of peripheral entities and partners destined to give support and follow up the activities of the primary digital networking circle with the aim of speeding up the system' routine, enhancing at the same time the accuracy, the security and the interaction of the system.

Subsequent peripheral layers are inserted into the system according to the need of each program.

In the example of FIG. 2, the Packages Provider (2) is escorted by several entities for assuring the operational viability and integrity of the programs such as sponsors (5) that give the material support for the prizes distribution, official agencies (6) that supervise the conformity and full accomplishment of the approved programs, cellphone companies (7) for installing a permanent or provisional massive wi-fi structure or any other streaming facility needed in a given venue, all media channels (8), among others that might be needed.

The Content Sources (4) group is formed by a large variety of Supporting Entities (9) such as but not limited to fans, commercial companies, banks, manufacturers and many others that directly or indirectly might interact with the Packages Provider (2), depending upon the activity that is going to be performed and attended by the End Users (3).

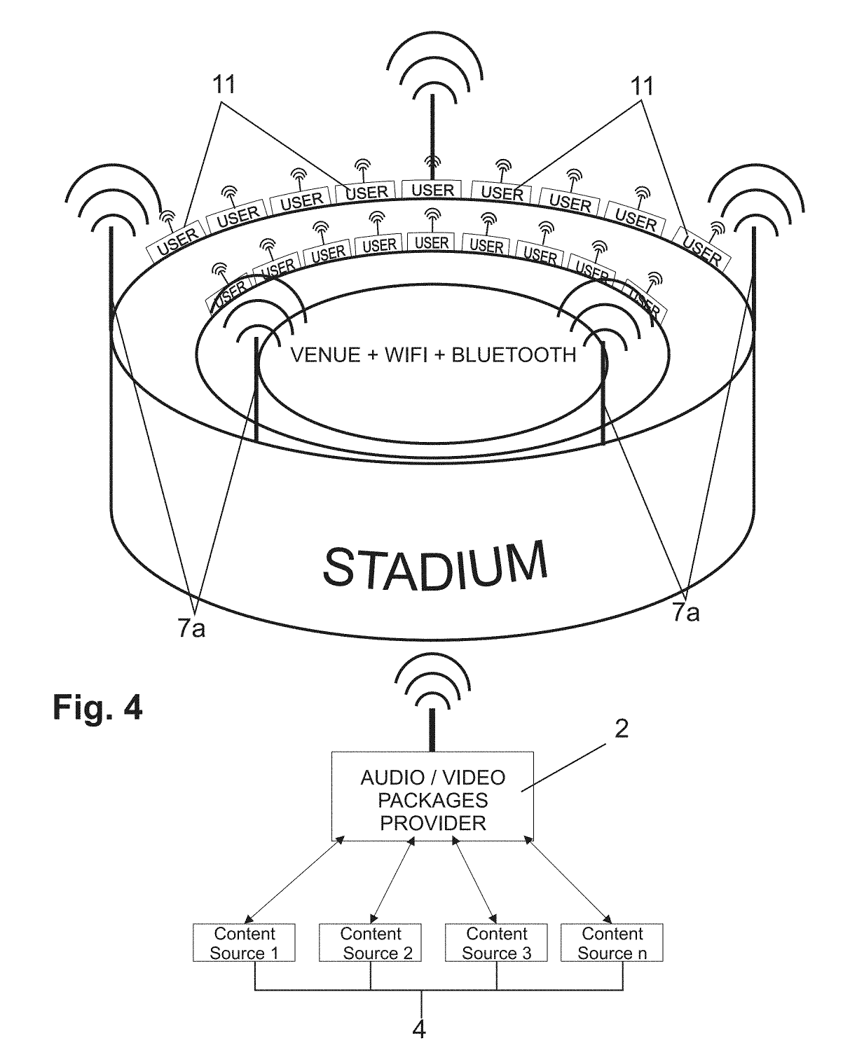

If for instance it refers to a football game, as exhibited in FIG. 4, then the interaction string will be stablished as from the Packages Provider (2) up to the Supporting Entities (9) therein involved, i.e., the two rival clubs at field along with theirs subsequent layer of supporters such as sponsors (10) and enthusiastic fans (11), these latter also referred to in this patent as End Users (3).

In this case, sound and video packages will be streamed by the Packages Provider to End Users (3) through the Venue's Digital Means (7a), as shown in FIG. 4.

The same pattern above described can also be transported for almost any other kind of mass public activity where a crowd is gathered in a venue for attending music shows, cinemas, theatres, religious cults, school classes, external political meetings and many others, as it will better explained through the following figures.

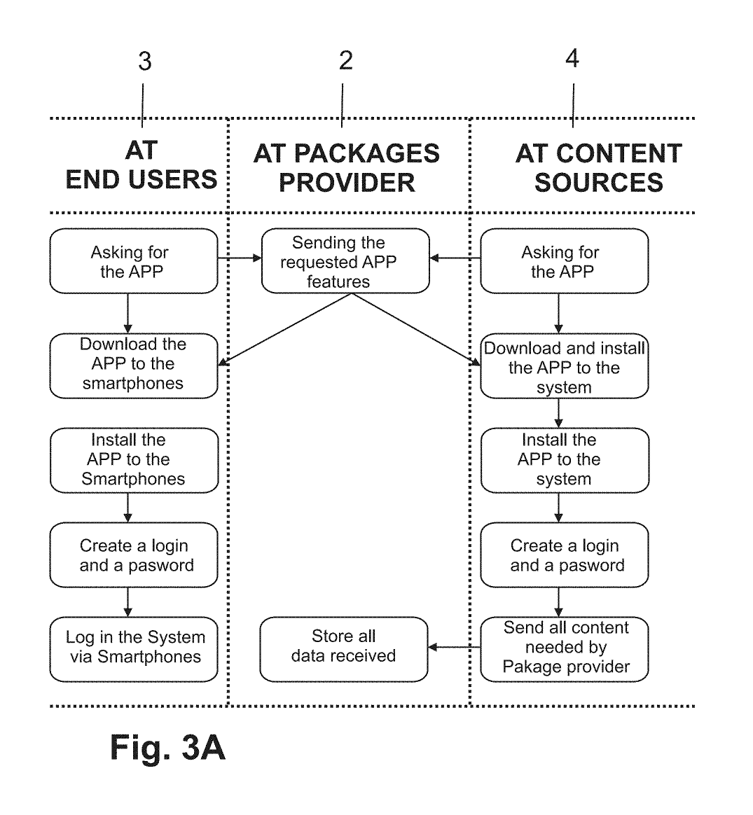

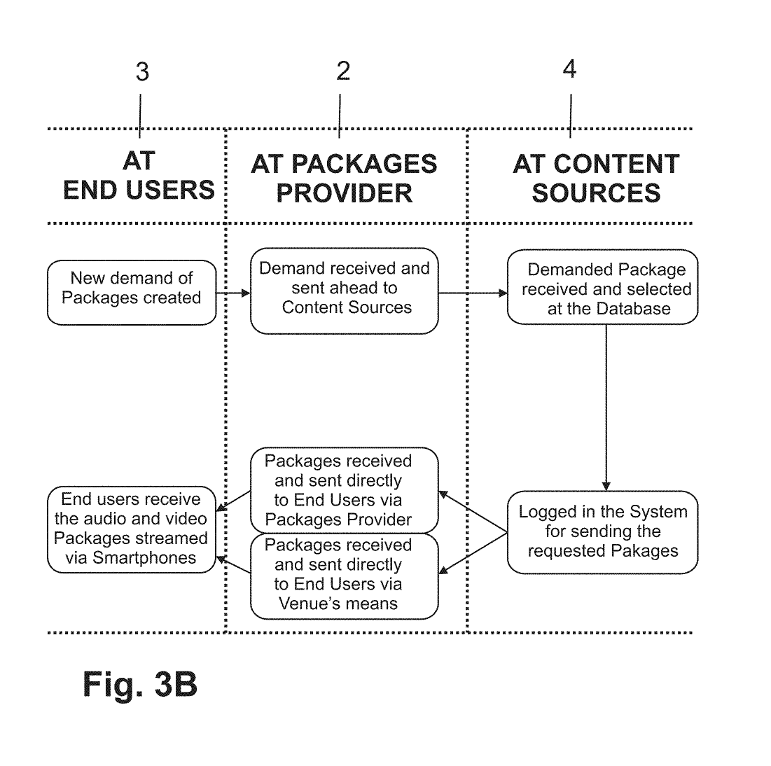

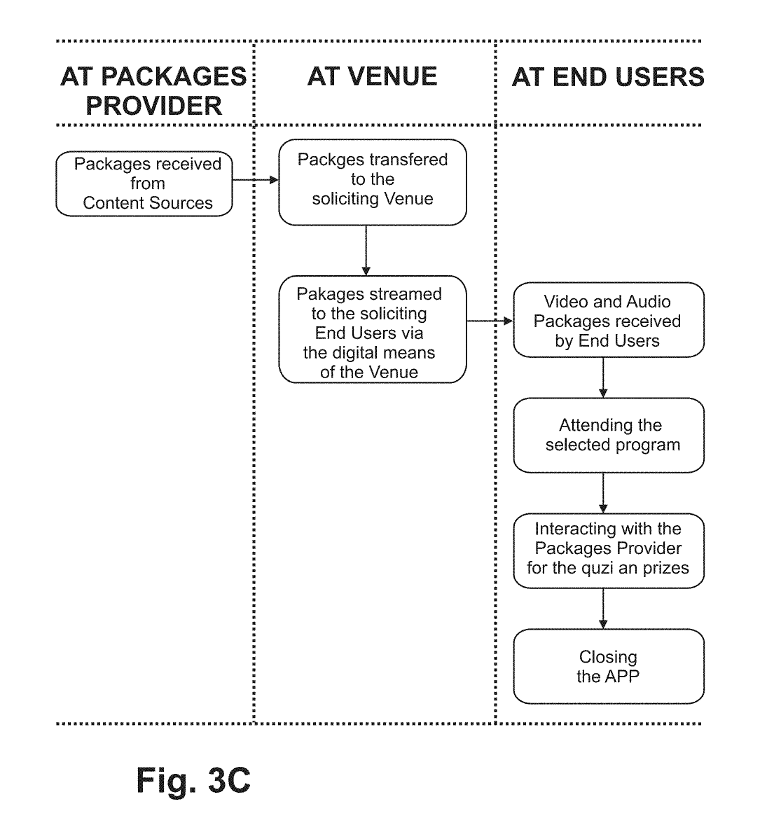

FIG. 3A is an overview flowchart illustrating the first stage to be accomplished for creating an operational network encompassing the End Users (3), the Packages Provider (2) and the Content Sources (4).

The creation of the operational Ace System network not shown in FIG. 3A starts when the Content Sources (4) is invited by the Packages Provider (2) to adhere to the system. If accepted, they will accomplish with all contractual formalities for a permanent lodging of that Content Source (4) that from then on will exchange the required data with the Packages Provider (2).

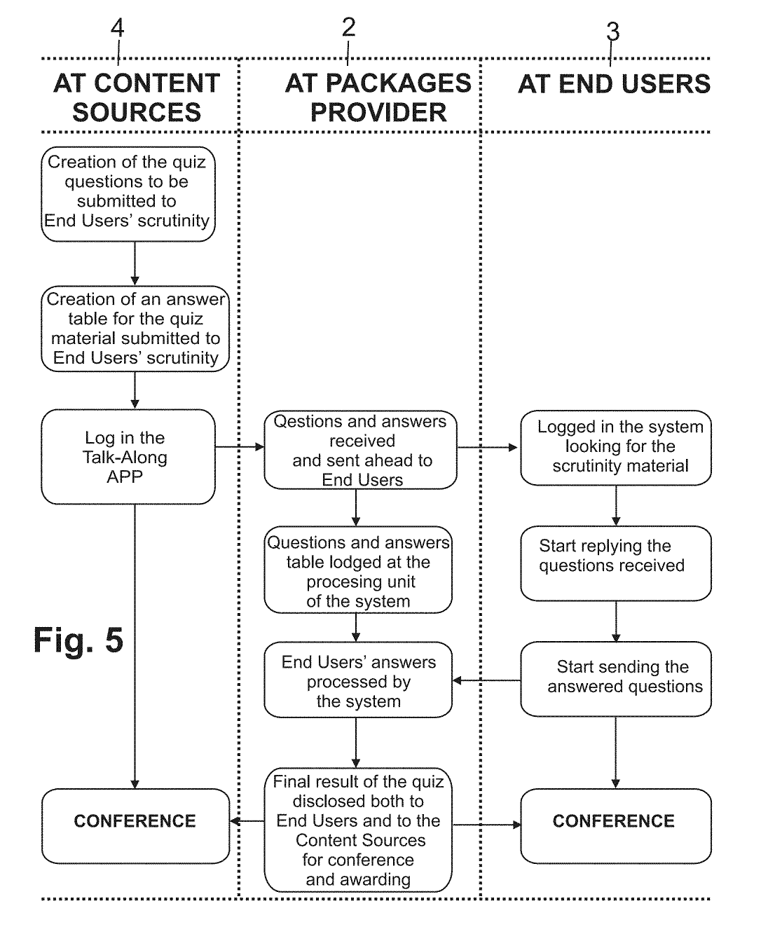

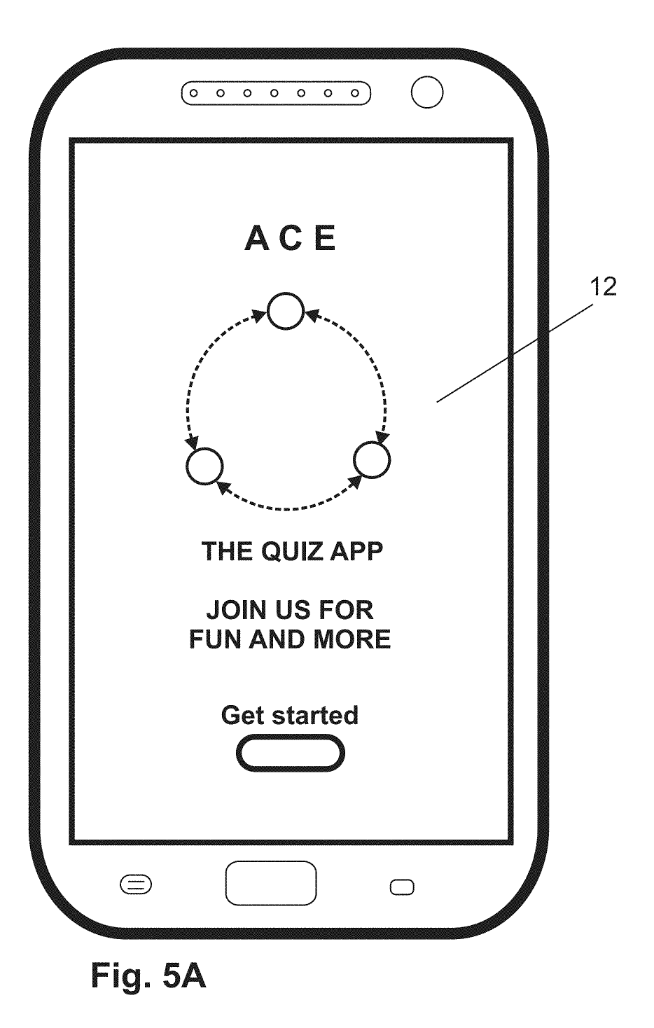

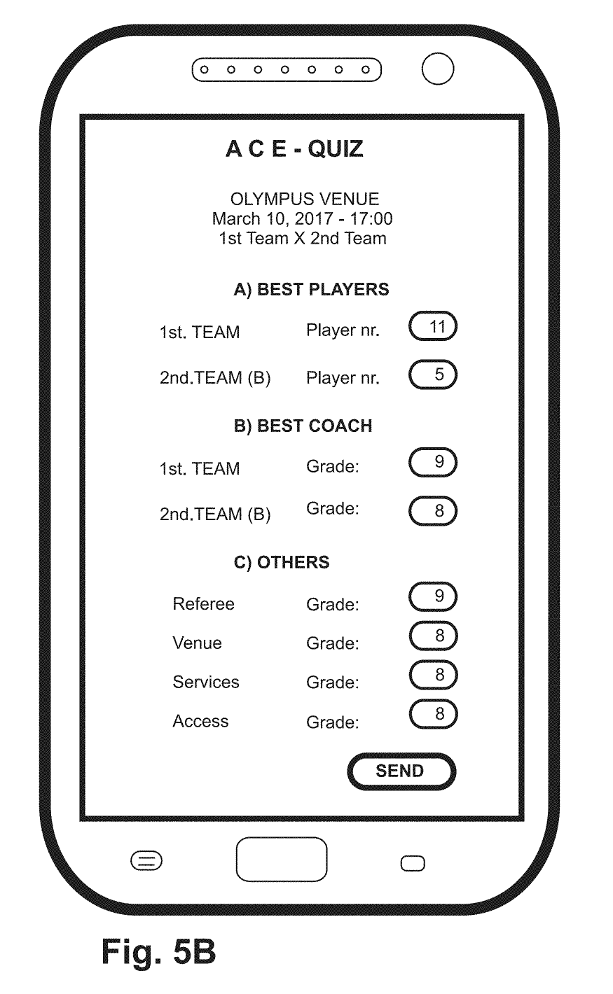

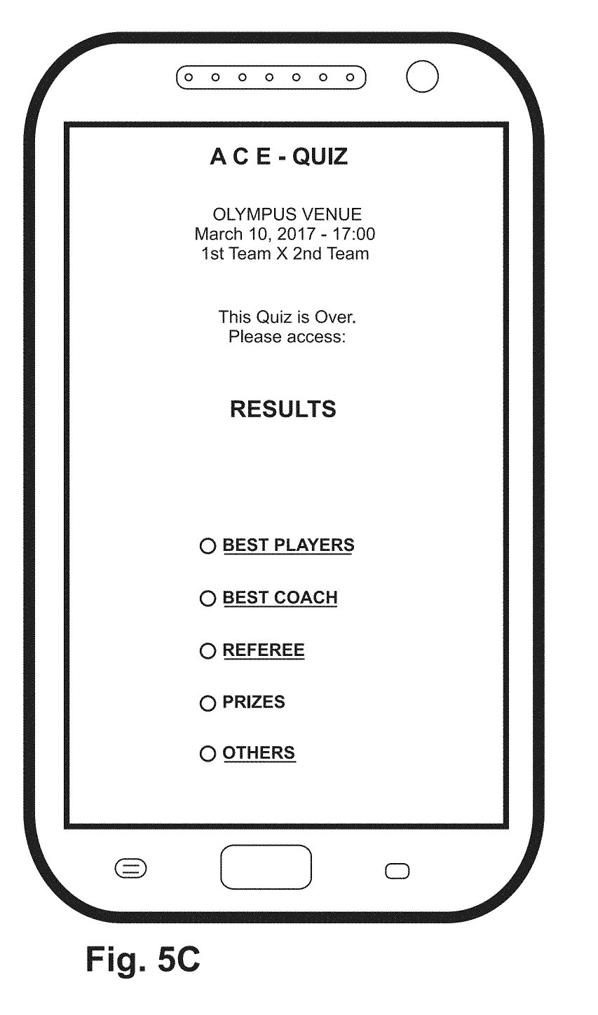

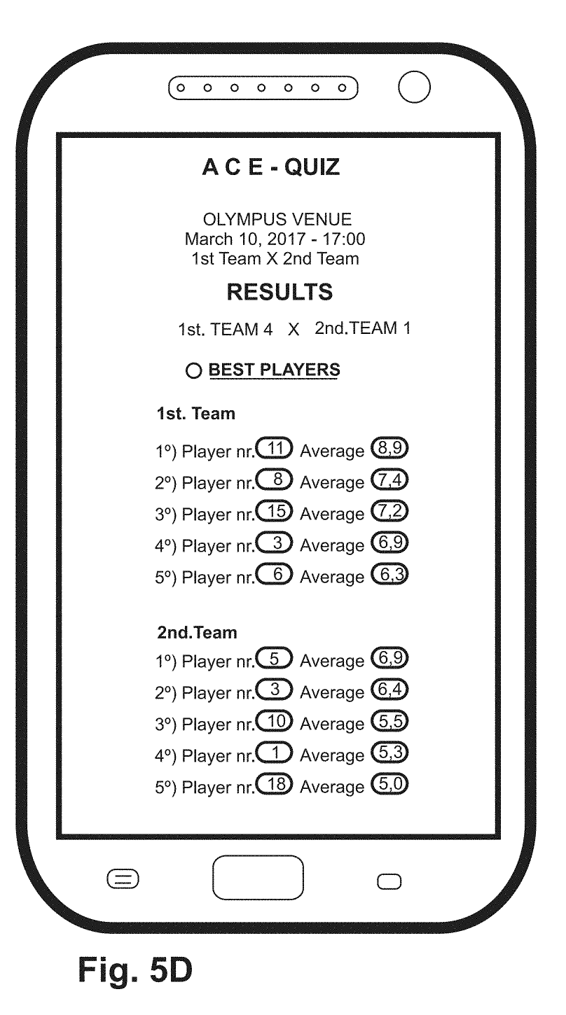

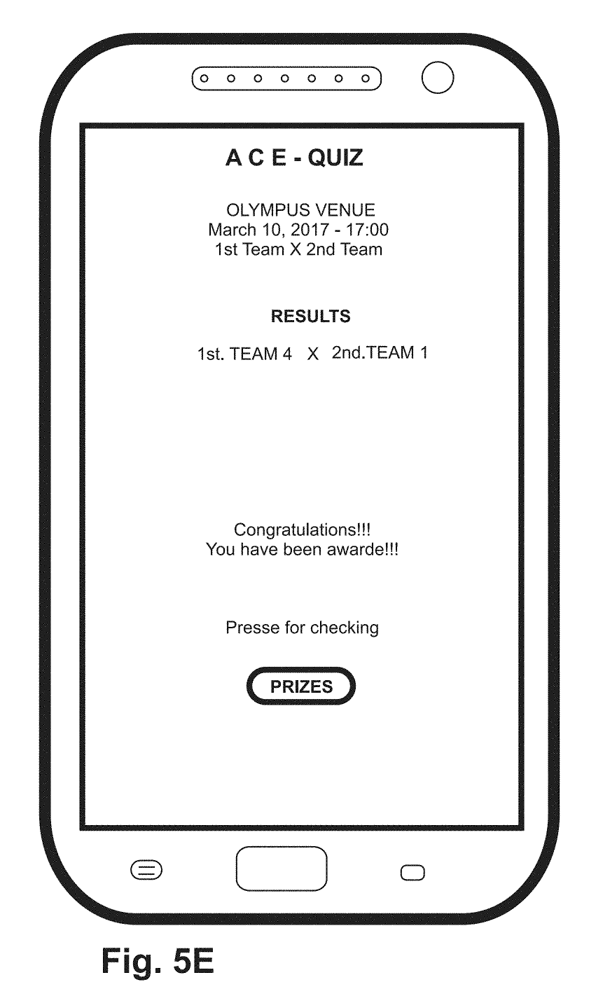

Thus and as depicted by FIG. 3A, both the Content Sources (4) and the End Users (3) access through an Internet connection the Users' Interface (12) shown at FIG. 5A aiming to download and install the APP in order to be registered in the system, so they can afterwards create a login name and a password which will be later on recognized by the system.

Now that they are registered in the Ace System APP they can start operating the system each one from its side, as depicted by FIG. 3B and as such the End Users (3) will proceed to the right venue to attend the elected program during which they will be able to connect and interact with the Packages Provider (2) for using all the resources of the APP, and likewise the Content Sources (4) will receive through the Packages Provider (2) the End Users (3) requests that will be treated accordingly and sent back to Packages Provider (2) and thence to the End Users (3).

Thus, and as depicted by the flow chart of FIG. 3B, a new package content is required by an End Users (3) to the Packages Provider (2) that immediately send it ahead to the related Content Sources (4) that, upon receiving the demand shall prepare a digital reply comprising the required content.

At this point End Users (3) are ready to use the APP as from the venue they are in and the Content Sources (4) are ready to meet End Users (3) demands simply by transmitting them through the Packages Provider (2).

FIG. 3C is an overview flowchart illustrating how the sound and video packages are streamed by the Packages Provider (2) to End Users (3) through the Venue's Digital Means (7a), as shown in FIG. 4, as provided by the Ace System.

Thus, and upon receiving the sound and video packages from the Content Sources (4), the Packages Provider (2) immediately stablishes a contact with the soliciting Venue so they can be likewise streamed to the End Users (3), according to their demands which can vary depending on the side (team, music band etc.) they are supporters of, being that side defined in the moment they have logged in in the system.

It is important to consider that for the aim of commercial reasons, the wi-fi or similar connection stablished with End Users (3) should be of the highest quality possible and preferably might be given as courtesy by the Cellphone Companies (7) as part of a campaign to boost their list of clients.

FIG. 4 shows therefore, as said before, the streaming string formed as from the Content Sources (4), passing through the audio and sound Packages Provider (2) and thence to the Venue's Digital Means (7a) which will finally stream the sound and audio packages to the related End Users (3) demanders.

FIG. 5 is an overview flowchart illustrating an example of operational routine followed by the system for stablishing a productive interaction between End Users (3) and the Content Source (4) through the implementation of a rewarded quiz program.

The quiz program of the present patent is primarily a ludic activity much more aimed for fun of the End Users (3).

However it can also be used for secondary purposes of great interest not only for the Content Sources (4) and theirs partners but also as a research basis for the protagonists of mass programs such as sport clubs, music bands as well as any other that might be counting on the good results of their shows for public satisfaction.

Thus, and according to the flowchart of FIG. 5, the quiz routine starts when the Content Sources (4) create a list of questions to be answered by the End Users (3) and send it onto the Packages Providers (2) jointly with the list of answers for those questions, after they have been logged at the Ace System APP, as shown up by the FIG. 5A.

Upon receiving the quiz material, the Packages Provider (2) from one side stores the content received in its database for later checking of the answers received from End Users (3) for consequently define those who have been entitled for a prize according to the number of right answers they have replied, and from the other side to have that material streamed to the End Users' (3) smart phones firstly to be answered by them and secondly for the later conference of their answers. An example of such questions, among many others, is disclosed through FIG. 5B.

Once the quiz material is received, the End Users (3) who are also logged in the Ace System's APP keep that material stored in theirs smartphones to be used as from the very start moment of the quiz which is digitally informed by the Packages Provider (2) to End users (3) who are given a feasible period of time to conclude theirs answers up to the closing of this period of time when that specific quiz program will be not anymore available for receiving the End Users' (3) answers.

Then, the Packages Provider (2) start scrutinizing all the material received in order to ascertain the right answers received by each one of the End Users (3) who will be then ranked for being rewarded, according to the regulation approved for each quiz program. The awarded End Users (3) will be then receiving from the Packages Provider (2) an immediate and general digital communication via, for instance, SMS—Short Message Service, WhatsApp or any other feasible mean, preferably when they are still inside the venue in order to create a positive vibe among them, whilst the final result of that specific quiz program will be disclosed for all End Users' (3) through the Users' interface (12) at the Ace System APP according to the example disclosed by FIG. 5C.

Said disclosure might contain all data and information relevant for the End Users (3) and for the Content Sources (4) and associated partners (10) as a whole such as a list of right answer, the amount of prizes awarded, the statistics and summary of votes granted at each one of the ballot categories in immediate and accumulated basis, as exhibited by FIG. 5d.

Specifically for awarded End Users (3), the Ace System will generate an individual congratulation message stating as well the prizes they have been entitled for, as disclosed by FIG. 5E.

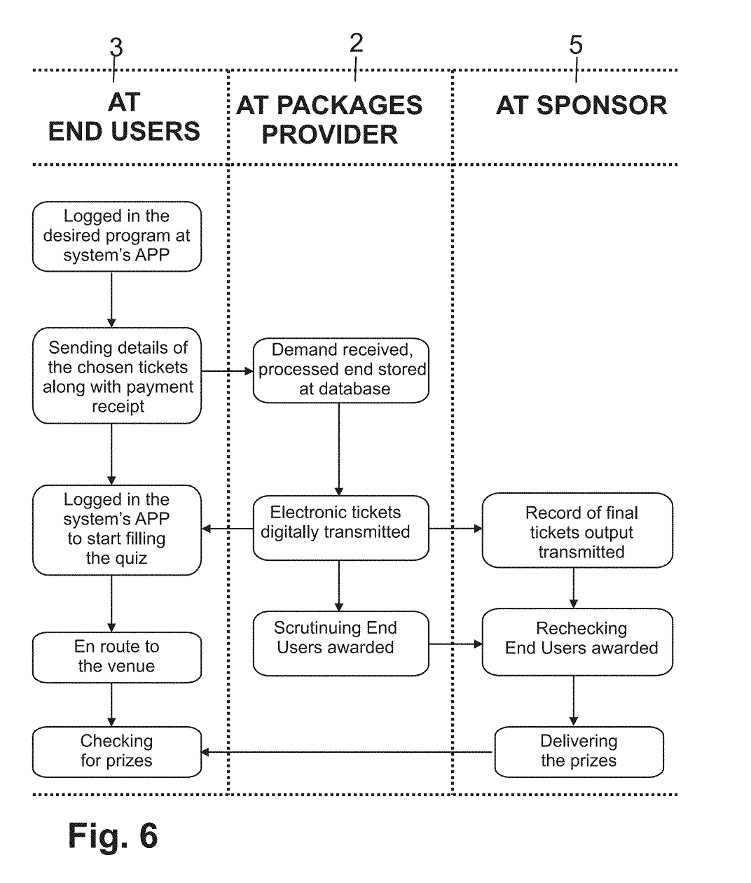

FIG. 6 schematically illustrates the embodiment of a system for selling tickets for the programs by which an End User (3) might be rewarded when buying his ticket through the Ace System selling facilities.

This system that might be based upon sponsorship by supporting entities, may consider the distribution of prizes in proportion of a certain quantity of tickets sold and may vary as from free tickets up to up to prizes of higher value in connection with the availability of the related sponsors (10).

Inventor: Newlands; Paulo R. Jannotti

(rio de janeiro, rj, brazil)

### Awarded Content Exchanger Management System

What is claimed is:

1. An Awarded Content Exchanger Management System provided for collective and simultaneous digital streaming of sound and video packages as from a pivot to groups of individuals forming a crowd that is gathered in the same venue, at the same moment and for the same common objective, being such a system and method capable of organize, display and stream a plurality of messages containing those sound and video packages to the public in an individualized manner even when they are gathered in the same venue and for the same purpose, and holding smartphones loaded with a responsive and dedicated APP wherein said streaming is captured by theirs smartphones' APP in such a way that the same packages of sound and video will be received by all of them in real time, at the same time and for the same purpose and with the same content, however through an individualized way of data transmission.

2. The Awarded Content Exchanger Management System as recited in claim 1 wherein said system comprises at least a pivot Packages Provider, Content Sources and End User holding smartphones.

3. The Awarded Content Exchanger Management System as recited in claim 1 wherein said system includes rewarding the users with prizes, pursuant to theirs participation in the system's programs.

4. The Awarded Content Exchanger Management System as recited in claim 1 wherein said system comprises a dedicated, responsive APP aimed to be loaded to the smartphones of End Users registered in the system and that wants to access it when they are participating in a given public program of general interest wherein said system comprises the emissions of packages for streaming audio and video contents from Content Sources to a plurality of End Users whose smartphones are equipped with the proper APP and capable therefore to receive said streamed packages wherein said system also comprises a plurality of End Users of smartphones fitted with the proper APP capable therefore to search and receive digital packages loaded with audio and video contents when said End Users are gathered in a common venue for attending a program of common interest.

5. The Awarded Content Exchanger Management System as recited in claim 1 wherein said system comprises that the dedicated APP be under the administration and control of a Package Provider unit through which all packages loaded with audio and video contents requested from Content Sources passes, are selected and sent forward to the End Users of the system.

6. The Awarded Content Exchanger Management System as recited in claim 1 wherein said system comprises the utilization of wired or wireless streaming technology such as BLUETOOTH, WIFI as well as any other technological mean that might be available at the selected venues, to stream audio and videos packages, transfer data and broadcast contents, programs or information between devices wherein said system comprises a Package Provider unit, or server, which might digitally transmit to a variety of End Users, packages loaded with audio and video contents, received from a variety of Content Sources.

7. The Awarded Content Exchanger Management System as recited in claim 1 wherein said system comprises the ability of concurrently and in real time streams through the user's smartphone devices the same audio and videos programs that in a given moment are being reproduced locally through the common audio and video means locally existing.

8. The Awarded Content Exchanger Management System as recited in claim 1 wherein said system comprises a variety of Content Sources of video and audio packages previously logged in the Package Provider unit and activated through password codes.

9. The Awarded Content Exchanger Management System as recited in claim 1 wherein said system includes the ability of keeping the streaming of the video and audio packages towards the smartphones sets fully synchronized to the same timing pace of the video and audio programs being streamed by the audio and video means available locally at the same moment.

10. The Awarded Content Exchanger Management System as recited in claim 1 wherein said system includes the deployment of a permanent or provisional hardware structure for the streaming of audio and video packages at the selected venue in order to support the high volume of accesses from End Users.

11. The Awarded Content Exchanger Management System as recited in claim 1 wherein said system includes the ability of the Package Provider unit for simultaneously receiving and processing firstly a plurality of logins aimed to open up the Package Provider's data base for searching of audio and video digital packages from a plurality of user, and secondly the ability of streaming out the selected audio and video digital packages by that plurality of logged in users.

12. The Awarded Content Exchanger Management System as recited in claim 1 wherein said system_{—} includes the creation of a dedicated social network among the users of a specific program in which they will be entitled to evaluate, for instance, the strong and weak points observed in the content presented by that program.

13. The Awarded Content Exchanger Management System as recited in claim 1 wherein said system includes the ability of associating, gathering and process all End User's doubts, queries and evaluations about the content of the program's exhibited themes such as an anthem, a program, a class at the school or at office, a music show, a sports session or any other event selected by those users in the available database at the Packages Provider Unit or at the Content Sources, or even at the Internet according to a menu displayed at the smartphone's screen which can also be accessible by other means such as a voice searcher or any other compatible mean.

14. An Awarded Content Exchanger Management System comprising a Packages Provider that embeds all necessary means to accomplish its functions as the central axis of the Ace System wherein it is Outfitted with all required hardware and software devices including strong servers attended by multiple internet connections being also in charge for the administration of the whole Ace System and therefore capable of processing simultaneously a huge amount of data coming in and going out from its related partners namely the End Users and the Content Sources, wherein the digital relationship network so created leads the Packages Provider to be able to get in close contact with the others members of that digital circle as the head member of the group, being the one which holds the administration power to start, manage and finish all the programs created within the system's environment.

15. The Awarded Content Exchanger Management System as recited in claim 19 wherein End Users are the orientation driver of the system whose preferences, tendencies and behaving are observed, analyzed and accounted in order to ascertain a general evaluation level about the programs presented what is done through the rewarding quiz.

16. The Awarded Content Exchanger Management System, as recited in claim 19, wherein the Content Sources are formed by entities or even regular people that can supply the system with the necessary content to allow the formulation of the questions that are to be submitted to the End Users so they can be entitled to receive the prizes determined by the system.

17. The Awarded Content Exchanger Management System, as recited in claim 19, wherein the Packages Provider, the End Users and the Content Sources form a circle around an Internet Environment also including a second layer of peripheral entities, partners and sponsors destined to supply the material and financial support needed to speed up the system' routine and enhance at the same time the accuracy, the security and the interaction of the system.

18. The Awarded Content Exchanger Management System, as recited in claim 19, wherein those supporters might include official agencies for supervising the conformity and full accomplishment of the approved programs, cellphone companies, for installing a permanent or provisional massive wi-fi structure or any other streaming facility needed in a given venue, all media channels, among others that might be needed.

19. The Awarded Content Exchanger Management System, as recited in claim 19, wherein the sound and video packages are streamed by the Packages Provider to End users through the venue's own digital means.

20. The Awarded Content Exchanger Management System, as recited in claim 19, wherein an operational Ace System network is created when the Content Sources adhere to the system by creating a login and a password, download the system's APP and abide to the contractual formalities for a permanent lodging at the system aiming to exchange data with the Package Provider.

21. The Awarded Content Exchanger Management System, as recited in claim 19, wherein End Users proceed to the chosen venue where they connect and interact with the Packages Provider in order to use the resources offered by the APP and the Content Sources receive from the Package Provider the demands from End Users which are treated adequately and send back to Package Provider and thence to the End Users.

22. The Awarded Content Exchanger Management System, as recited in claim 19, wherein a rewarded quiz program is stablished comprising the End Users and the Content Source aiming to research End Users' preferences.

23. The Awarded Content Exchanger Management System, as recited in claim 19, wherein a quiz list to answered by End User is created by the Content Sources and sent for storage at the Package Providers' database along with the list of answers for those questions, and thence to End Users' smartphones, wherein End Users are given a feasible period of time to conclude theirs quiz answers.

24. The Awarded Content Exchanger Management System, as recited in claim 19, wherein the awarded End Users will receive from the Packages Provider an immediate general digital communication about the final quiz prizes which will be also disclosed at the Ace System APP End Users' Interface (12) along with any their relevant information such as the list of right answer, the amount of prizes awarded, the statistics and summary of votes granted at each one of the ballot categories in immediate and accumulated basis.
